(19) United States
(12) Patent Application Publication
(10) Pub. No.: US 2005/0120167 A1
(43) Pub. Date: Jun. 2, 2005

(54) Information recording device, information reproduction devic, method, and computer program

(76) Inventors: Junji Oiwa, Kanagawa (JP); Makio Yamaki, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/500,401

(22) PCT Filed: Dec. 27, 2003
(86) PCT No.: PCT/JP03/13696

(30) Foreign Application Priority Data
Oct. 28, 2002 (JP) 2002-312164

(51) Int. Cl. G06F 12/00

(52) U.S. Cl. 711/112

(57) ABSTRACT

Provided is an apparatus and method for continuously recording data onto a plurality of information recording means and reproducing it. As reproduction control information corresponding to recording data, generated are reproduction procedure information on which a reproducing procedure is recorded and reproduction management information on which link information to the reproduction procedure information is stored. In the case of continuously executing data recording to a plurality of information recording means, a plurality of pieces of reproduction procedure information are generated corresponding respectively to the plurality of information recording means, to set link information to the plurality of pieces of reproduction procedure information in one piece of the reproduction management information. Content reproduction process, based on one piece of reproduction management information, acquires the corresponding piece of reproduction procedure information to the storage information about each recording medium, to effect reproduction control based on the respective pieces of reproduction procedure information.

### TECHNICAL FIELD

The present invention relates to an apparatus and method for recording and reproducing information and computer program. More concretely, it relates to an apparatus and method for recording and reproducing information and computer program capable of recording such video/audio data as not to be fully recorded to data recording means, such as one hard disk, onto data recording means, such as a plurality of hard disks, and reproducing, without encountering discontinuity, the data divisionally recorded over the plurality of data recording means.

### BACKGROUND ART

Recently, large-capacity data storage devices are widespread including hard disks and optical disks. Those storage devices are actively utilized to record the content received through, for example, a broadcast station or satellite and reproduce the recorded content out of the large-capacity data storage device, such as hard disk and optical disk. Particularly, large-capacity hard disks are available cheap in price. Thus, hard disk recorders are toward accelerating spread, in place of the convention al video tape recorders. The hard disk recorder is advantageous in that it is easy to perform such random access, data edition and processing as not to be enjoyed on the convention al video tape recorder. Further rapid spread is expectable toward the future.

In the case of storing moving-image data or the like to a storage medium such as a hard disk or optical disk, it is a general practice to store it by decreasing the data amount through encoding (compression). Meanwhile, the data to be conveyed through a network such as the Internet, in many cases, is sent by decreasing its data amount through encoding (compression), so that the coded data at the reception side is stored to a storage medium and decoded (decompressed) during reproduction.

The most known approaches of image compression processing include an MPEG (Moving Pictures Experts Group) compression technique. The MPEG stream, generated by such MPEG compression, is stored in a storage medium, such as a hard disk or a DVD, or in an IP packet conforming to an IP (Internet Protocol) and transferred over the Internet, thereby improving the efficiency of data transfer and data storage.

MPEG is an art to realize image compression with quality. The MPEG2 compression scheme, employed the most at present, is a compression technique in combination of discrete cosine transform (DCT) as compression utilizing in-screen correlation, moving compensation as compression based on screen-to-screen correlation, and Huffman coding as compression based code string correlation. In MPEG2, there is haven a GOP (group of pictures) structure as a group having a plurality of frames based on three elements called I-picture, P-picture and B-picture, in order to implement prediction coding using motion compensation.

In the case of reproducing the frame data having such a group, there is a need of an encoding process based on group data, i.e. GOP. The compressed data recorded on a disk or the like, although not necessarily recorded by segmentation based on GOP, is stored dividable based on GOP by the meta information including information for determining a content storage position and enabling to read out the content. During reproduction with decoding, reproduction process is made by carrying out decoding based on segment.

In the hard disk recorder mounting a tuner section capable of receiving terrestrial wave, satellite broadcast or the like, the data received through the tuner is recorded to a data storage device such as a hard disk. The digital data received through a terrestrial wave, satellite broadcast or the like, is generally compression-processed by the MPEG scheme or the like. Accordingly, in the case that the digital video signal supplied from these sources is recorded to the hard disk or the like, the compressed video signal is processed for recording directly to the hard disk.

In the case of receiving an analog signal and recording it to a data storage device such as a hard disk, processing is made for conversion into a digital signal by A/D conversion and thereafter encoding (compression) process is made to carry out a recordation process to the hard disk or the like.

Referring to FIG. 1, explanation is made on a hard disk recorder for recording/reproducing the convention al MPEG stream.

First explained is the process upon data recording. The RF signal received at the antenna is supplied to a tuner-a 101, a tuner-b 102. The tuner-a 101 is a digital-signal tuner while tuner-b 102 is an analog-signal tuner.

The transport stream (TS), as a result of channel selection, wave form detection and demodulation by the digital-signal tuner, or the tuner-a 101, is descrambled through a descrambler 104 and then inputted to a demultiplexer (DEMUX) 110. Incidentally, the transport stream (TS) is in an MPEG stream form on IEEE1394.

On the other hand, for the signal channel-selected, waveform-detected and demodulated by the analog-signal tuner, or the tuner-b 102, NTSC-schemed video-signal decoding process is made and audio-signal digital conversion process is made in an NTSC decoder/audio A/D 105. After MPEG coding process made in a MPEG encoder 106, input is made to the demultiplexer (DEMUX) 110.

Furthermore, for the input signal from an external input 103 for inputting data from another source connected with other video apparatuses and the like, decode process is made on the NTSC-schemed video-signal while digital conversion process is made on the digital signal in an NTSC decoder/audio A/D 105. After MPEG coding process made in an MPEG encoder 106, input is made to the demultiplexer (DEMUX) 110.

The TS signal, inputted to the demultiplexer (DEMUX) 110 by way of a descrambler 104, is separated by an PID (packet identification) as a packet identifier, set by a CPU 130 (host CPU), into video PES (Packetized Elementary Stream) as desired packetized stream data or ES (Elementary Stream) data as elementary stream data not multiplexed, similar audio PES data corresponding to the audio or ES data, and further section data as management data including channel-selection, addition al information data.

The video PES data or video ES data is inputted to the rear-staged video decoder 111, the audio PES data or audio ES data is sent to the rear-staged audio decoder 112, and the section data is sent to the rear-staged memory 113.

Meanwhile, the video PES data and the audio PES data are recorded to a recording medium (hard disk) 123 by way of an information detecting device 120 and a scrambler 121. An information detecting device 120 detects the pieces of reproduction procedure information and reproduction management information concerning video/audio data (content), and records these pieces of reproduction procedure information and reproduction management information to the recording medium (hard disk) 123. The scrambler 121 carries out a scrambling process on the video data and the like, and records the scrambled data to the recording medium (hard disk) 123.

The video decoder 111 decodes the video PES data or ES data supplied from the demultiplexer 110, and outputs a video signal to a rear-staged video display device 114 whereby video reproduction is effected. The audio decoder 112 decodes the audio PES data or ES data supplied from the demultiplexer 110, and outputs an audio signal to a rear-staged audio output device 115 whereby audio reproduction is effected.

The section data including channel-selection, addition al information data is stored to the memory 113. However, these of data are readout by the host CPU 130, and processed on software into use for various processes, such as channel selection. A memory 142 is used as a work area of the host CPU 130, a software storage area and the like.

Incidentally, the arrangement shown in FIG. 1 has an arrangement for reading out user information (right information) stored on an user-held IC card 141 through a card interface (I/F) 140, in order to realize a restricted reception scheme for content reproduction limited to the user entitled for viewing. Depending upon the user information (right information) stored on the IC card 141, the host CPU 130 executes control to allow for viewing a content under limited reception.

The reproduction management information manages link information to reproduction procedure information on which a reproducing procedure of the video/audio data to be reproduced is recorded and control information. The reproduction procedure information manages stream data, stream management information and content information.

Now explained is a process for reproducing the video/audio data (content) recorded on the recording medium (hard disk) 123.

From the recording medium (hard disk) 123, the reproduction management information and reproduction procedure information managing the video/audio data (content) recorded on the recording medium (hard disk) 123. The read-out video/audio data is descrambled by a descrambler 122, and then video/audio data is inputted to the video decoder 111 and audio decoder 112. After decode process is carried out in the video decoder 111 and audio decoder 112, a video signal is outputted to the rear-staged video display device 114 while an audio signal is to the rear-staged output device 115 whereby content reproduction is effected.

Now explained is reproduction management information and reproduction procedure information, with reference to FIG. 2. Reproduction management information 205 and reproduction procedure information 206 is generated in a content recordation process, for example, to a recording medium (hard disk) 212, and stored, with correspondence to the content, to the recording medium (hard disk) 212. In reading the content out of the recording medium (hard disk) 212 and reproduction process, it is read out of the recording medium (hard disk) 212 and applied for reproduction control.

The reproduction management information 205 is information to be generated upon recording the content and utilized in reproducing the content, storing management information on which the order to reproduce the contents is described. Specifically, this includes a name representative of the corresponding reproduction procedure information 206, and a content beginning position [In] and content end position [Out] as time information representative of a beginning and end position of the content.

The reproduction procedure information 206 is information to be generated upon recording the content and utilized in reproducing the content, storing management information of the content recorded continuously to one recording medium. Specifically, this includes content management information comprising a video/audio section data file name (stream file name), time information, video header information, audio header information, meta data information comprising link information to stream data, etc., packet ID, and copy control information.

These pieces of reproduction management information 205 and reproduction procedure information 206 are stored and held, together with the content, on the recording medium (hard disk) 212. Concerning generation and application process arrangement of these pieces of information, explanation is made on a process example for concurrently executing content recordation and reproduction, with reference to FIG. 2.

In FIG. 2, the upper of the line A-A′ represents a process under software control while the lower thereof represents a process by hardware.

On the software side, there is an upper layer process (application) 204 as a recording/reproducing processing program for identifying a command or the like from the user and executing the overall control of recordation or reproduction. This carries out supervisory control, including to set a lower process based on user's input or the like.

In the case of executing recordation/reproduction control, setting is made of a recordation control process 201 for executing recordation control or a reproduction control process 202 for executing reproduction control, in the lower level, under management of the upper layer process (application program) 204. The process is placed under control by the respective process thus set.

On the hardware side, there are a recording section hardware 210 configured, for example, by hardware, etc. for executing descramble, scramble, MPEG decode, encode processes or A/D conversion, etc., the reproducing section hardware 111 for executing descramble, MPEG decode process, etc., and the recording medium (hard disk) 212 as a recording medium for the content.

In this process example, the recordation control process 201 records the content to the recording medium (hard disk) 212 and executes a process to the generate reproduction management information 205 and the reproduction procedure information 206. On the other hand, the reproduction control process 202 carries out a process to read the content out of the recording medium (hard disk) 212 according to the reproduction management information 205 or the like and to send it to the reproduction section hardware 211.

In the example shown in FIG. 2, the content, reproduction management information and reproduction procedure information are premised for recording to one recording medium (hard disk). Namely, it is presumed that in the case of recording one content to the recording medium (hard disk), one piece of reproduction procedure information is generated correspondingly to the one content, to generate reproduction management information set with a link to the generated reproduction procedure information whereby storage is to the same recording medium (hard disk).

However, the information recording/reproducing apparatus for storing data and executing reproducing process, in many cases, has a plurality of recording means. It is the frequent case for the user to store many contents onto a plurality of recording means and carry out a reproducing process. For example, hard disk recorders include those incorporating a plurality of hard disk devices, in order to increase data storage capacity.

In the arrangement having such a plurality of recording means, it was possible to set any of the recording means as a storage device for each content and make a storage by changing the recording medium based on content. However, there was a difficulty in reproducibly recording one content over a plurality of recording means without encountering discontinuation. With such a process, continuous data is possibly to be segmented. The non-reproducible data area is caused in the segmented point, possibly causing discontinuity in the data.

Accordingly, convention ally, even on a storage device having a plurality of recording means, in the event that the remaining capacity ran out, for example, on the hard disk under recordation process during recording one content, it was required to take a measure of suspending the content from recording.

In view of such a situation, in the case of recording a content to a removable, for example, optical disk, when one optical disk has a reduced amount of remaining capacity, unrecorded data is temporarily recorded to a large capacity buffer, so that, after changing the optical disk, the buffer-stored data is recorded to the second optical disk thereby realizing data storage free of discontinuations, which arrangement is disclosed in Patent Document 1 (JP-A-2002-157824), for example.

Patent Document 1 discloses a data recording apparatus capable of recording video/audio data high in image and sound quality not to be accommodated on one disk to a plurality of disks. The Patent document 1 shows an arrangement that having first control means for recording, when recording a series of data to a first optical disk, at least the continuing part of the series of data to a large capacity buffer when the remaining capacity of the first optical disk becomes a predetermined capacity or less, and second control means for reading out the data recorded on the large capacity buffer under control of the first control means and recording the read out data to the second optical disk when the first optical disk is changed to a second optical disk.

However, the art described in this patent document merely shows an arrangement enabling to store and record data by the application of a buffer. This is different from the arrangement that, reproduction management information as reproduction control information and reproduction procedure information are generated during recording a content, and stored together with the content to a recording medium such as a hard disk or the like so that reproduction control can be effected based on the reproduction management information and reproduction procedure information during reproduction. Accordingly, no disclosure is made at all on handling reproduction management information and reproduction procedure information where a content is continuously recorded to a plurality of recording mediums.

### DISCLOSURE OF THE INVENTION

The present invention has been made in view of the foregoing problems, and it is an object thereof to provide an apparatus and method for recording and reproducing information and computer program capable of continuously recording a content to a plurality of recording mediums without discontinuation and executing a reproduction process of the content freely of discontinuation under reproduction control based on the reproduction management information and reproduction procedure information, in an arrangement for generating reproduction management information as reproduction control information and reproduction procedure information during recording a content and storing them together with the content to a recording medium such as a hard disk, and effecting reproduction control based on the reproduction management information and reproduction procedure information during reproduction.

The first aspect of the present invention lies in an information recording apparatus for executing a data recordation process, the information recording apparatus characterized by comprising:
a plurality of information recording means for recording data; and
a recordation control process executing section for executing a data recordation process to the information recording means and a generation process of control information during data reproduction;
the recordation control process executing section having a configuration for
generating, as the control information, reproduction procedure information on which a reproducing procedure of reproducing data is recorded and reproduction management information on which link information to the reproduction procedure information is stored, during the data recordation process; and wherein
in a case to execute a data recordation process to a plurality of information recording means, a plurality of pieces of reproduction procedure information are generated corresponding respectively to the plurality of information recording means, to execute a process of storing link information to the plurality of reproduction procedure information to one piece of the reproduction management information.

Furthermore, in one embodiment of the information recordation process of the invention, the recordation control process executing section has a configuration for executing, in a case to continuously execute a data recordation process to a plurality of information recording means, a process of storing the link information to the plurality of reproduction procedure information to one piece of the reproduction management information, and executing a process of storing continue information representative of whether or not recording a same content in a corresponding data storage domain to individual pieces of reproduction procedure information, continuously to a next piece of reproduction procedure information.

Furthermore, in one embodiment of the information recordation process of the invention, the recordation control process executing section has a configuration for executing, in a case to continuously execute a data recordation process to a plurality of information recording means, a process of storing the link information to the plurality of reproduction procedure information to one piece of the reproduction management information, and executing a process of storing end information representative of whether or not corresponding to a final piece of reproduction procedure information, in a corresponding data storage domain to an individual piece of reproduction procedure information.

Furthermore, in one embodiment of the information recordation process of the invention, the recordation control process executing section has a configuration for executing a process of storing, in each piece of the reproduction procedure information, management information on data continuously recorded on one recording medium, and storing information enabling to determine a storage position of the data.

Furthermore, in one embodiment of the information recordation process of the invention, the recordation control process executing section has a configuration for executing a comparison process of an available capacity for recording data between the plurality of information recording means, and selecting information recording means having a greater available capacity thereby commencing a data recordation process.

Furthermore, in one embodiment of the information recordation process of the invention, the recordation control process executing section has a configuration for executing a comparison process of a remaining capacity of the information recording means under data recording with a preset threshold, and executing continuously a data recordation process to another information recording means on condition that the remaining amount becomes less than the threshold.

Furthermore, in one embodiment of the information recordation process of the invention, the recordation control process executing section has a configuration for executing a process of generating first reproduction procedure information when commencing a data recordation process to the information recording means, and storing link information to the first reproduction procedure information to the reproduction management information, and generating new second reproduction procedure information in a case to execute continuing data recording to different information recording means, storing link information to the second reproduction procedure information to the reproduction management information, and executing a setting process of continue information representative of whether or not recording a same content in a corresponding data storage domain to the first reproduction procedure information, continuously to a next piece of reproduction procedure information.

The second aspect of the invention lies in an information reproduction apparatus for executing a data reproducing process, the information reproduction apparatus characterized by comprising:
a plurality of information recording means for subject-of-reproducing data; and
reproduction control process executing section for executing a reproducing process of data stored on the information recording means, depending upon control information;
the reproduction control process executing section having a configuration for
acquiring, as the control information, reproduction procedure information on which a reproducing procedure of reproducing data is recorded and reproduction management information on which link information to the reproduction procedure information is stored, during data recordation process; and wherein
in a case there are a plurality of pieces of reproduction procedure information set linked to the reproduction management information, the plurality of pieces of reproduction procedure information are switched in order and applied as control information, and reproduction-of-subject data is acquired based on an individual piece of reproduction procedure information from different information recording means thereby effecting a reproduction process.

Furthermore, in one embodiment of the information reproduction apparatus, the reproduction management information stores, in a corresponding data storage domain to each piece of reproduction procedure information, continue information representative of whether or not recording a same content continuously to next reproduction procedure information, and the reproduction control process executing section is configured for executing a process of determining whether or not to continuously execute reproduction control depending on another piece of reproduction procedure information, depending upon a setting of continue information in reproduction management information set for reproduction procedure information corresponding to data under reproduction.

Furthermore, in one embodiment of the information reproduction apparatus, the reproduction control process executing section is configured for acquiring, from the reproduction procedure information, management information on data continuously recorded on one recording medium and information enabling to determine a storage position of data thereby effecting a data reproduction control process.

Furthermore, the third aspect of the invention lies in an information recording method for an information recording apparatus having a plurality of information recording means for recording data, the information recording method comprising:
a control information generating step of generating reproduction procedure information on which a reproducing procedure is recorded as reproduction control information corresponding to recording data, and reproduction management information on which link information to the reproduction procedure information is stored, during the data recordation process; and wherein
the control information generating step is to execute a process that
in a case to continuously execute a data recordation process to a plurality of information recording means, a plurality of pieces of reproduction procedure information are generated corresponding respectively to the plurality of information recording means, to store link information to the plurality of reproduction procedure information to one piece of the reproduction management information.

Furthermore, in one embodiment of the information recording method of the invention, in a case to continuously execute a data recordation process to a plurality of information recording means, a process of storing the link information to the plurality of reproduction procedure information to one piece of the reproduction management information is executed, and a process of storing continue information representative of whether or not recording a same content in a corresponding data storage domain to individual pieces of reproduction procedure information, continuing to a next piece of reproduction procedure information, is executed.

Furthermore, in one embodiment of the information recording method of the invention, in a case to continuously execute a data recordation process to a plurality of information recording means, a process of storing the link information to the plurality of reproduction procedure information to one piece of the reproduction management information is executed, and a process of storing end information representative of whether or not corresponding to a final piece of reproduction procedure information, in a corresponding data storage domain to an individual piece of reproduction procedure information, is executed.

Furthermore, in one embodiment of the information recording method of the invention, included is a step of storing, in each piece of the reproduction procedure information, management information on data continuously recorded on one recording medium, and storing information enabling to determine a storage position of the data.

Furthermore, in one embodiment of the information recording method of the invention, further included is a step of executing a comparison process of an available capacity for recording data between the plurality of information recording means, and selecting information recording means having a greater available capacity thereby commencing a data recordation process.

Furthermore, in one embodiment of the information recording method of the invention, further included is a step of executing a comparison process of a remaining capacity of the information recording means under data recording with a preset threshold, and executing continuously a data recordation process to another information recording means on condition that the remaining amount becomes less than the threshold.

Furthermore, in one embodiment of the information recording method of the invention, further included is a step of executing a process of generating first reproduction procedure information when commencing a data recordation process to the information recording means, and storing link information to the first reproduction procedure information to the reproduction management information, and generating new second reproduction procedure information in a case to execute continuing data recording to different information recording means, storing link information to the second reproduction procedure information to the reproduction management information, and executing a setting process of continue information representative of whether or not recording a same content in a corresponding data storage domain to the first reproduction procedure information, continuously to a next piece of reproduction procedure information.

Furthermore, the fourth aspect of the invention lies in an information reproducing method for an information reproducing apparatus having a plurality of information recording means for subject-of-reproducing data, the information reproducing method characterized by comprising:
a control information acquiring step of acquiring, as the control information, reproduction procedure information on which a reproducing procedure of reproducing data is recorded and reproduction management information on which link information to the reproduction procedure information is stored, during the data recordation process; and
a reproduction control process step that, in a case there are a plurality of pieces of reproduction procedure information set linked to the reproduction management information, the plurality of pieces of reproduction procedure information are switched in order and applied as control information, and reproduction-of-subject data is acquired based on an individual piece of reproduction procedure information from different information recording means thereby effecting a reproduction process.

Furthermore, in one embodiment of the information reproducing method, the reproduction management information stores, in a corresponding data storage domain to each piece of reproduction procedure information, continue information representative of whether or not recording a same content continuously to next reproduction procedure information, and the reproduction control process step includes a step of executing a process of determining whether or not to continuously execute reproduction control depending on another piece of reproduction procedure information, depending upon a setting of continue information in reproduction management information set for reproduction procedure information corresponding to data under reproduction.

Furthermore, in one embodiment of the information reproducing method, the reproduction control process step includes a step of acquiring, from the reproduction procedure information, management information on data continuously recorded on one recording medium and information enabling to determine a storage position of data thereby effecting a data reproduction control process.

Furthermore, the fifth aspect of the invention lies in a computer program for executing an information recordation process in an information recording apparatus having a plurality of information recording means for recording data, the computer program characterized by comprising:
a control information generating step of generating reproduction procedure information on which a reproducing procedure is recorded as reproduction control information corresponding to recording data, and reproduction management information on which link information to the reproduction procedure information is stored, during the data recordation process; and
the control information generating step is to execute a process that
in a case to continuously execute a data recordation process to a plurality of information recording means, a plurality of pieces of reproduction procedure information are generated corresponding respectively to the plurality of information recording means, to store link information to the plurality of reproduction procedure information to one piece of the reproduction management information.

Furthermore, the sixth aspect of the invention lies in a computer program for executing an information recordation process in an information recording apparatus having a plurality of information recording means for recording subject-of-reproducing data, the computer program characterized by comprising:
a control information acquiring step of acquiring, as the control information, reproduction procedure information on which a reproducing procedure of reproducing data is recorded and reproduction management information on which link information to the reproduction procedure information is recorded, during the data recordation process; and
a reproduction control process step that, in a case there are a plurality of pieces of reproduction procedure information set linked to the reproduction management information, the plurality of pieces of reproduction procedure information are switched in order and applied as control information, and reproduction-of-subject data is acquired based on an individual piece of reproduction procedure information from different information recording means thereby effecting a reproduction process.

According to the arrangement of the invention, in an apparatus having a plurality of information recording means such as a plurality of hard disks or the like, generated are reproduction procedure information on which a reproducing procedure is recorded as reproduction control information corresponding to recording data, and reproduction management information on which link information to reproduction procedure information is stored. In the case of continuously executing data recordation to a plurality of information recording means, a plurality of reproduction procedure information are generated corresponding respectively to a plurality of pieces of reproduction procedure information, to provide a configuration storing link information to the plurality of pieces of reproduction procedure information to one piece of the reproduction management information. Accordingly, in a content reproduction process, even in case content recordation is being continuously executed to a plurality of recording mediums, reproduction procedure information corresponding to the storage information on each recording medium can be acquired based on one piece of reproduction management information, thus enabling to effect control based on the respective pieces of reproduction procedure information.

Furthermore, according to the arrangement of the invention, there is provided an arrangement that, in the case of continuously executing a data recordation process to a plurality of information recording means, a process of storing link information to a plurality of reproduction procedure information to one piece of reproduction management information is executed, and furthermore the corresponding data storage domain of an individual piece of reproduction procedure information stores a continue information of whether or not a same content is recorded to the next piece of reproduction procedure information. Accordingly, in the content reproduction process, the reproduction procedure information is acquired corresponding to the storage information on each storage medium, based on one piece of reproduction management information, thus enabling to effect control based on the respective pieces of reproduction procedure information.

Furthermore, according to the arrangement of the invention, there is provided, in an information recordation process, an arrangement for executing a comparison process in available capacity for recording data between a plurality of information recording means, selecting information recording means having a greater available capacity and commencing a data recordation process, further executing a comparison process of a remaining capacity of information recording means under data recordation with a preset threshold, and continuously executing the data recordation process to another information recording means, hence enabling to utilize efficient, proper recording means.

Incidentally, the computer program of the invention is a computer program to be provided by a storage medium, communication medium, e.g. storage medium such as CD, FD or MO, or by a communication medium such as a network, to a general-purpose computer system capable of executing various program codes. By providing such a program in a computer-readable form, processing is realized over the computer system in accordance with the program.

Further objects, features and merits of the present invention will be made apparent by the more detailed explanation based on the ensuing embodiments of the invention and accompanied drawings. In the specification, the system means a logical assembly configuration of a plurality of apparatuses and it is not limited to one in which apparatuses of respective constituents are disposed in a sing le casing.

### BRIEF DESCRIPTION OF THE DRAWINGS

FIG. 1 is a figure showing an arrangement of a hard disk recorder for recording/reproducing an MPEG stream.

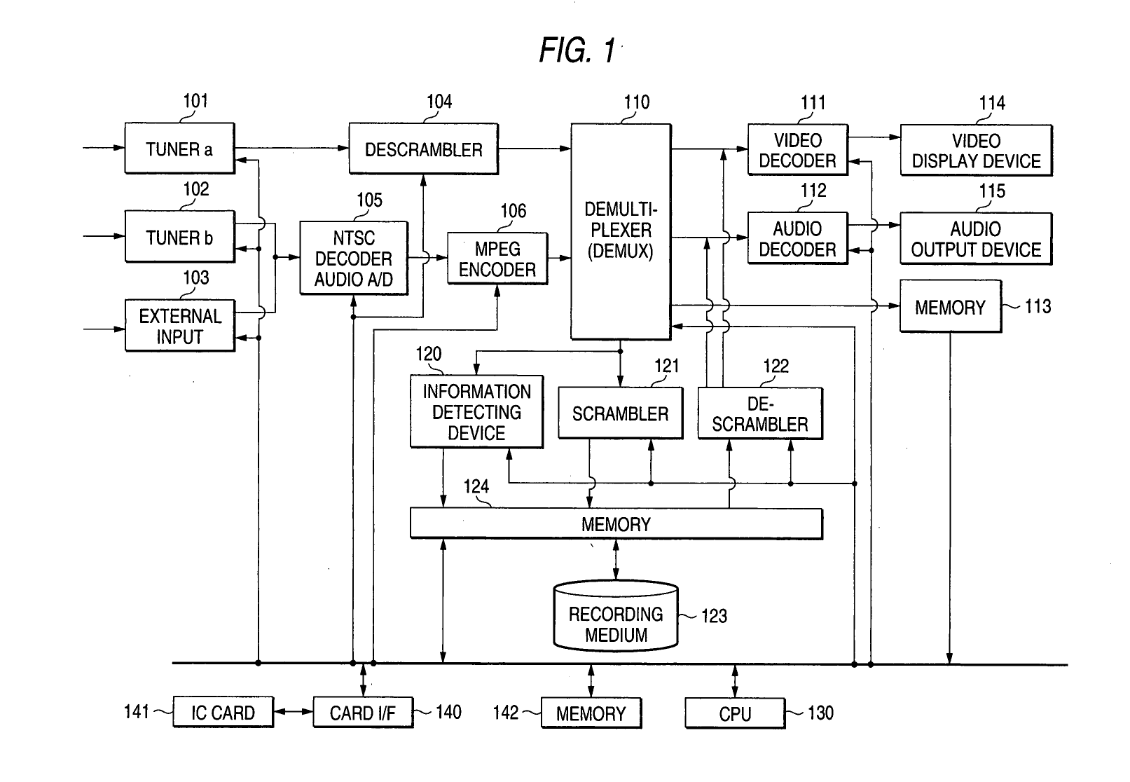

FIG. 2 is a figure explaining a process arrangement example for concurrently executing a content recordation process to a recording medium and a content reproducing process from the recording medium.

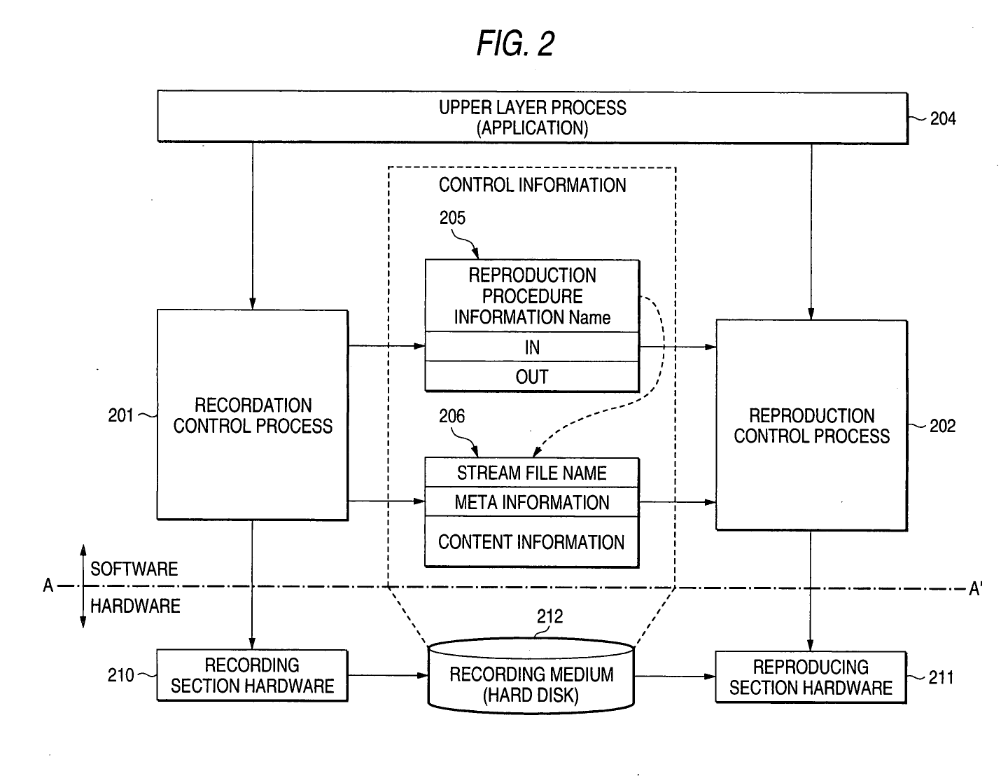

FIG. 3 is a figure showing an arrangement of reproduction management information and reproduction procedure information to be generated upon content recordation, and readout in a content reproducing process and applied to reproduction control.

FIG. 4 is a figure explaining the correspondence between a recordation beginning position [In] and recordation end position [Out] in reproduction management information and a GOP segmentation point.

FIG. 5 is a figure explaining a process arrangement in a content recordation control process on the information recording apparatus of the invention.

FIG. 6 is a figure showing a hardware arrangement example of an apparatus for executing a content recordation/reproduction control process in the invention.

FIG. 7 is a figure explaining a process arrangement in a content reproduction control process on the information recording apparatus of the invention.

FIG. 8 is a figure explaining the correspondence between reproduction management information and reproduction procedure information generated according to an arrangement of the invention and a content.

FIG. 9 is a figure explaining the correspondence between reproduction management information and reproduction procedure information generated according to an arrangement of the invention and a content.

FIG. 10 is a flowchart explaining a procedure in the content recordation control process on the information recording apparatus of the invention.

FIG. 11 is a flowchart explaining a procedure in the content reproduction control process on the information recording apparatus of the invention.

### BEST MODE FOR CARRYING OUT THE INVENTION

Hereunder, while referring to the drawings, explanation is made on an information recording apparatus, information reproducing apparatus, method and computer program thereof.

[Control Information Structure]

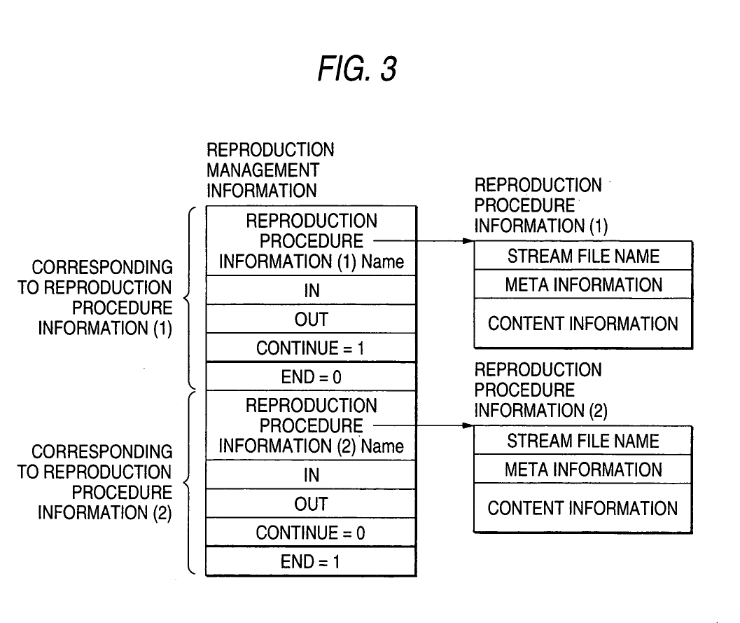

FIG. 3 shows a structure of a piece of reproduction management information and reproduction procedure information to be generated upon recording a content, and to be read out in a content reproducing process and applied in reproduction control, in the information recording apparatus, information reproducing apparatus and method thereof.

The reproduction management information is a piece of information to be generated upon recording a content and to be utilized during reproducing the content, storing therein apiece of managing information describing the sequence of contents to be reproduced. Specifically, this includes a name representative of the corresponding reproduction procedure information, and a content beginning position [In] and a content end position [Out] as time information representative of the content beginning and end positions. The content beginning position [In] is time information as content beginning position information set to a content-recordation beginning position by the recordation control process. The content end position [Out] is time data representative of an end position of content-recorded data to be updated by the recording control process as the content recordation process proceeds.

The reproduction procedure information is a piece of information to be generated upon recording a content and to be applied during reproducing the content, storing therein management information of a content continuously recorded to one recording medium. Specifically, this is Meta information comprising a video/audio section data file name (stream file name), time information, video header information, link information to the stream data and the like, including information for determining a content storage position and enabling to readout the content. Furthermore, there is included content management information comprising packet IDs, copy control information and like.

In the arrangement of the invention, in the case of storing a content to a plurality of recording mediums, reproduction procedure information is generated for each recording medium for recording the content. The example shown in FIG. 3 is on an example where one content is recorded onto two recording mediums. Two pieces of reproduction procedure information (1), (2) are shown as reproduction procedure information for the respective recording mediums.

In this manner, in the case of generating two pieces of reproduction procedure information, the reproduction management information is set by the management information corresponding to an individual piece of reproduction procedure information, as shown in FIG. 3. Specifically, a name representative of the corresponding reproduction procedure information, and a content beginning position [In] and a content end position [Out] as time information representative of the content beginning and end points, correspondingly to the respective pieces of reproduction procedure information (1), (2).

Furthermore, the reproduction management information applied in the arrangement of the invention stores a continue information representative of whether or not a same content is continuously recording to the next piece of reproduction procedure information. The continue information storing domain, when set by 1, represents that a same content is continuously recorded to the next reproduction procedure information. Namely, this represents that recording is executed continuously further onto a different recording medium. The continue storing domain, when set by 0, represents that a same content is not continuously recorded to the next reproduction procedure information, i.e. that recording is not continuously made to a further different recording medium.

Meanwhile, there is haven a piece of end information representative of whether corresponding to the final piece of reproduction procedure information. The end information storing domain, when set by 1, represents that there is no following reproduction procedure information and hence corresponding to the final piece of reproduction procedure information. The end information storing domain, when set by 0, represents that there is the following piece of reproduction procedure information.

As mentioned before, the reproduction management information includes a content beginning position [In] and a content end position [Out]. The content beginning position [In] is time information as content beginning position information to a content-recordation beginning position while the content end position [Out] is time data representative of an end position of content-recorded data to be updated as the content recordation process proceeds.

The data to be processed in the information recording or reproducing apparatus of the invention is MPEG-compressed data. The MPEG2 compression scheme used today the most frequently is a technique in combination of discrete cosine transform (DCT) as compression utilizing in-screen correlation, motion compensation as compression based on screen-to-screen correlation, and Huffman coding as compression based on code strings. In MPEG2, there is haven a GOP (group of pictures) structure that is a group having a plurality of frames based on three elements called I-picture, P-picture and B-picture, in order to make a prediction coding using motion compensation.

In the case of reproducing the frame data having such a group, there is a need for a decoding process based on group data, i.e. based on GOP. The compressed data, recorded on a disk or the like, is not necessarily recorded by GOP-based segmentation. However, by the Meta information containing information enabling to determine a storage position of a content and to read out the content. During reproduction with decoding, reproduction process is carried out by carrying out a segment-based decoding.

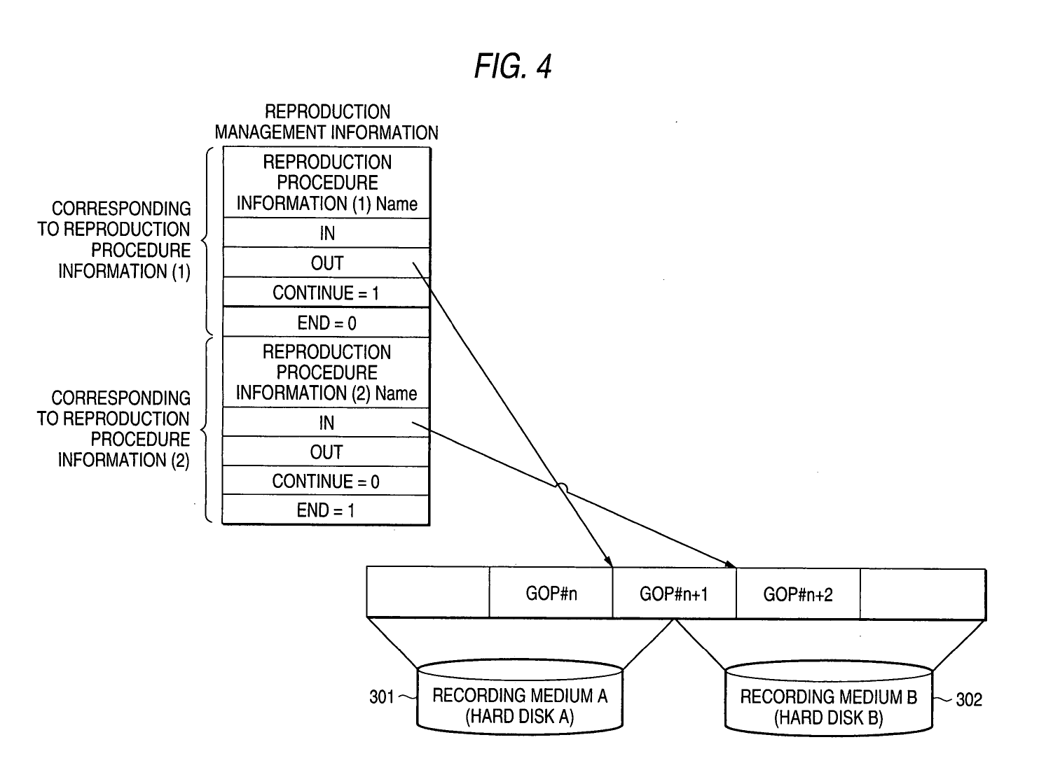

The foregoing recordation beginning position [In] and record end position [Out] of reproduction management information is set with data, based on GOP, representative of GOP segmentation positions. The record end position [Out] of reproduction management information is sequentially updated by the recordation control process as the recordation process proceeds. During reproduction in the reproduction control process, reproduction process is carried out by recognizing are producing position by a GOP segmentation point.

Where continuously recording a content to a plurality of recording mediums, the efficiency of use is higher on a recording unit not based on GOP. As shown in FIG. 4, in the case that the former half [GOP#1-GOP#n] of a content is recorded to a recording medium A (hard disk A) 301 and the latter half [GOP#n+2−] of the content is to a recording medium B (hard disk B) 302, the recordation end position [Out] corresponding to the reproduction procedure information (1) in the reproduction management information is given by data corresponding to the GOP#n end position, while the recordation beginning position [In] corresponding to the reproduction procedure information (2) in the reproduction management information is given by data corresponding to the GOP#n+2 start position. [GOP#N+1] is recorded, by division, onto the recording medium A (hard disk A) and the recording medium B (hard disk B).

[Content Recordation Process]

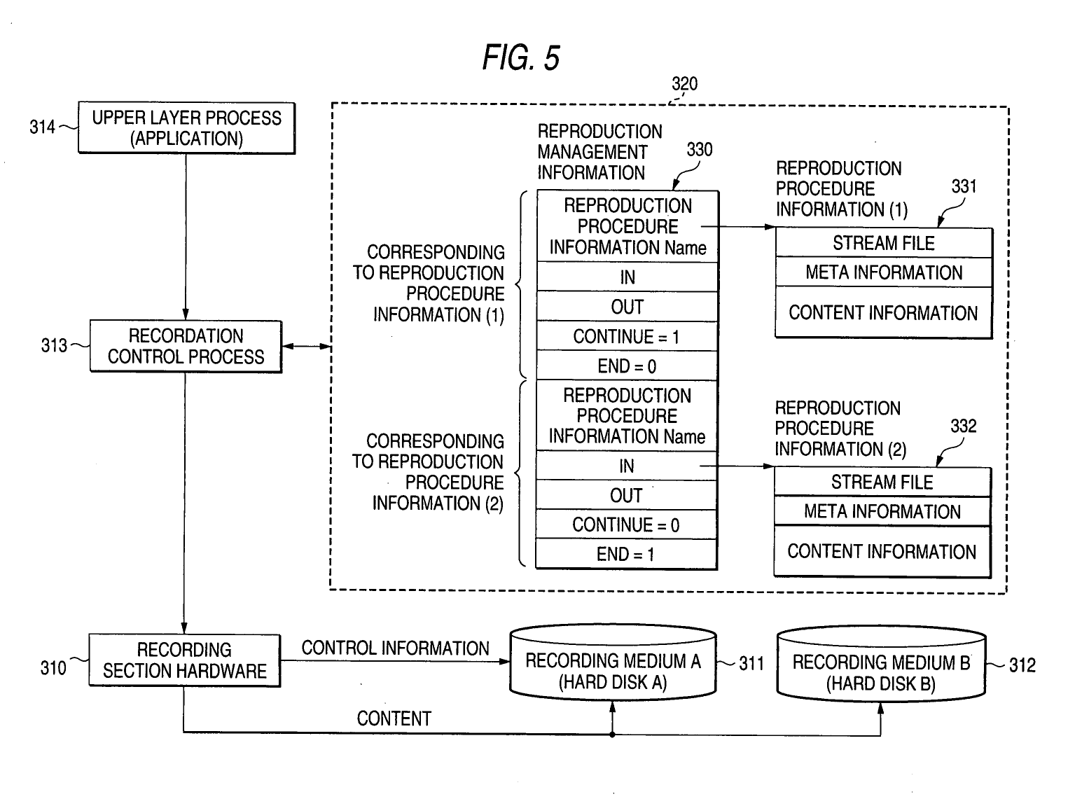

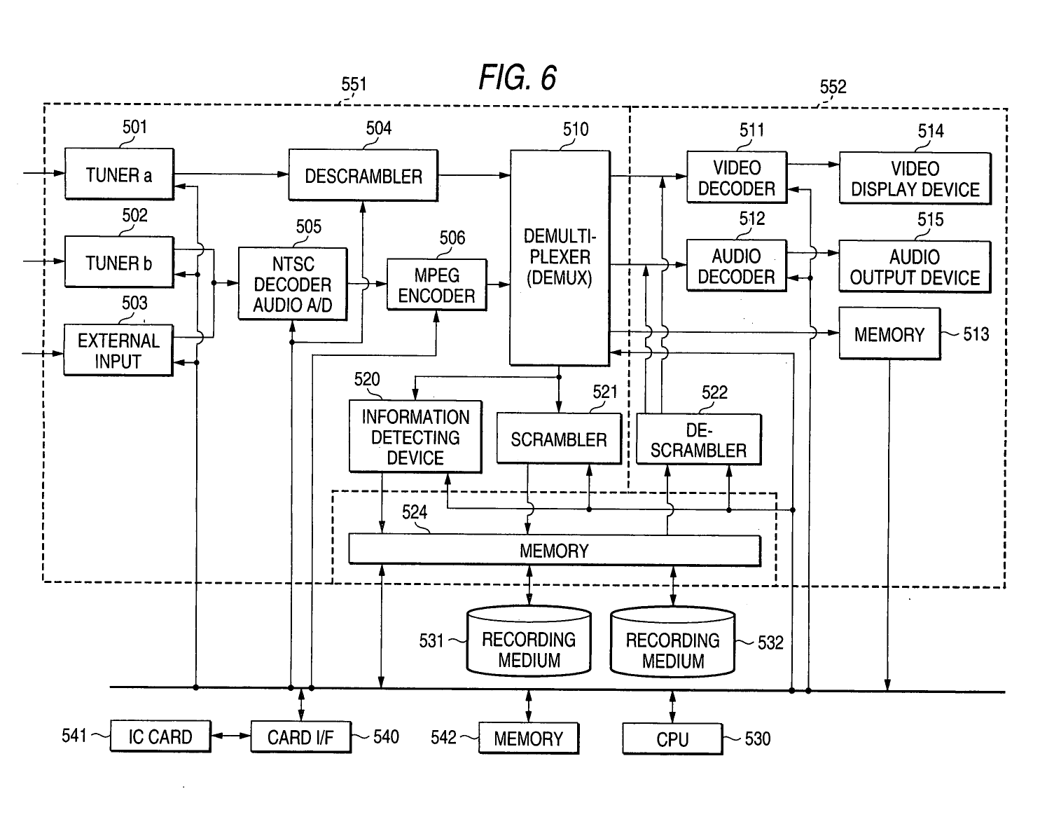

Now explained is a process arrangement in the content recording control process by the information recording apparatus of the invention, with reference to FIG. 5. Incidentally, FIG. 6 shows a hardware arrangement example of the information recording apparatus.

In FIG. 5, an upper layer process (application) 314 refers to an execution software of a recordation/reproduction processing program for identifying a command, etc. of from the user and executing the overall control for recordation or reproduction, for example. Under management of the upper layer process (application program) 314, a recordation control process 313 is set for executing recordation control each time new recordation process, e.g. based on content unit, takes place. With the processes set respectively, processing is placed under control.

The upper layer process (application) 314 and recordation control process 313 is an execution processing section under control of software. The recordation control process, during recording a content, generates control information 320, including reproduction management information 330 and reproduction procedure information 331, 332, to execute a process of recording those together with the content onto the recording medium (hard disk).

This embodiment explains a process example that a content is to be recorded onto the two recording mediums (hard disks) of recording medium A (hard disk A) 311 and recording medium B (hard disk B) 312. Incidentally, the control information 320, including reproduction management information 330 and reproduction procedure information 331, 332, is stored to any one of the recording mediums (hard disks), e.g. the first recording medium A (hard disk A) 311 to start to record the content.

It is a recording section hardware 310 that is to actually execute data write process. The arrangement of the recording section hardware 310 is shown in detail arrangement in the information recording/reproducing apparatus shown in FIG. 6. The dotted-lined region 551 in FIG. 6 represents the major configuration of recording section hardware. The dotted-lined region 552 in FIG. 6 represents the major configuration of reproducing section hardware.

Incidentally, the upper layer process (application) 314 and the recordation control process 313 are execution processes based on software control. These processing programs, stored in a memory 542 in a hardware arrangement shown in FIG. 6 or recording medium (hard disk) 531, 532, are to be read out and executed by a CPU 530.

Accordingly, for the upper layer process (application) 314 and recordation control process 313, the CPU 530 shown in FIG. 6 serves as a process executing section, in a hardware sense. Namely, the CPU 530 acts as a section for executing the upper layer process (application) and recordation control process shown in FIG. 5 and the reproduction control process to be explained later.

As shown in FIG. 6, the hardware for executing an information recordation process includes a tuner a501 as a digital-signal tuner, a tuner b502 as an analog-signal tuner, an external input 503 connected with other video appliances, a descrambler 504 for executing a process of descrambling, an NTSC decoder/audio A/D 505 for executing a decode process on an STSC-schemed video signal and digital-conversion process on an audio signal, and an MPEG encoder 506 for executing an MPEG encode process.

Furthermore, there are included a demultiplexer (DEMUX) 510 for executing a process of a separation into video PES (packetized elementary stream) data as desirably packetized stream data by PID (packet identifier), ES (elementary stream) data not to be multiplexed, similar audio PES data or ES data corresponding to the audio, and section data as management data including channel-selecting operation and addition al information data, an information detecting device 520 for executing a process to detect a piece of reproduction procedure information and reproduction management information about video/audio data (content), a scrambler 521 for executing a scrambling process on a video data, etc. to be recorded to the recording mediums (hard disks) 531, 532.

On the other hand, a reproducing section hardware 552 has a descrambler 522 for executing to descramble the data read out of the recording mediums (hard disks) 531, 532, a video decoder 511 and an audio decoder 512 for executing a process of decoding video compressed data and audio compressed data, and a video display device 514 and an audio output device 515 for outputting decoded data. Furthermore, there is provided a memory 513 for storing section data including channel-selecting operation and addition al information data. Those of data are to be read out by the host CPU 530 and processed on software, and to be used in desired operation.

A memory 524 is utilized as a temporary buffer domain for write data to the recording mediums (hard disks) 531, 532 or read data out of the recording mediums (hard disks) 531, 532. This is a domain included in both the recording section hardware 551 and the reproducing section hardware 552. The CPU 530 as a process executing section and a memory 542 for use as program storing and work domains are also a domain included in both the recording section hardware 551 and the reproducing section hardware 552.

Incidentally, the hardware arrangement of FIG. 6 is in an arrangement to read out user information (right information) stored on an user-held IC card 541 through a card interface (I/F) 540 in order to realize a restricted-reception scheme enabling content reproduction restricted to the qualified user for viewing. Under control of the host CPU 530 based on the user information read out of the IC card 541, viewing limitation is realized on a content of restricted reception. However, this arrangement of restricted viewing is not a requisite configuration in this invention.

Referring back to FIG. 5, explained is a recordation control process to be executed during recording a content. The recordation control process 313, when there are a plurality of recording mediums for storing contents, first executes selection processes as to which one is to be used as a content-recordation start medium. These selection processes are by the method, for example, of acquiring pieces of available capacity information on a plurality of recording mediums and selecting a recording medium having a greater available capacity. Otherwise, selection may be by the user or on the basis of default setting information.

Here, there are the recording medium A (hard disk) 311 and the recording medium B (hard disk) 312. The recording medium A (hard disk) 311 has a greater available capacity, and hence the recording medium A (hard disk) 311 is assumably selected as a content-recordation start medium.

Then, the recordation control process 313 generates the reproduction management information 330 corresponding to a recordation content, and links the procedure information (1) 331 to it. Namely, to the reproduction management information 330 is registered a reproduction procedure information 331 name, thereby executing a process of linking between the reproduction procedure information 331 and the reproduction management information 330.

Furthermore, the recordation control process 313 stores the information for use in content reproduction to the reproduction procedure information 331. Specifically, an information detecting device 520 (see FIG. 6) extracts the information for use in content reproduction from the video PES data and audio PES data of the video/audio data (content), and stores it to the reproduction procedure information 331. The storage information includes a file name (stream file name) of video/audio section data, time information, video header information, Meta information comprising link information to stream data or the like, packet ID, and content management data comprising copy control information, etc.

Furthermore, the recordation control process 313 sets content recordation start time information to a content beginning position [In] of the reproduction management information. The content end position [Out] is time data representative of an end position of content-recorded data to be updated as content recordation process proceeds. As noted before, this records GOP-based recordation end position information together with recordation completion to the GOP-based recording medium (hard disk A) 311, and sequentially updates it.

Furthermore, the recordation control process 313, during recording a content, verifies the remaining capacity of the recording medium under content recordation, i.e. the recording medium A (hard disk A) 311 in this case at a regular interval, and compares it with a preset threshold. In case the remaining capacity of the recording medium A (hard disk A) 311 is equal to or greater than the threshold, the content recordation process is continued to the recording medium A (hard disk A) 311.

When the remaining capacity of the recording medium A (hard disk A) 311 is smaller than the threshold, the recordation control process 313 verifies the remaining capacity of the other recording medium A (hard disk A) 311. In case the recording medium B (hard disk B) 312 has a remaining capacity equal to or greater than the threshold, the process moves to a content recordation process to the recording medium B (hard disk B) 312. In case the recording medium B (hard disk B) 312 has a remaining capacity less than the threshold, content recordation process is not made to the recording medium B (hard disk B) 312 and content recordation is ended.

When the remaining capacity of the recording medium B (hard disk B) 312 is equal to or greater than the threshold and the content recordation process is moved to the recording medium B (hard disk B) 312, the recordation control process 313 sets 1 to the continue information domain in the corresponding data of reproduction management information 330 to the reproduction procedure information (1). This is information representative of a same content is continuously executed recorded to the other recording medium B (hard disk B) 312 and the recordation is made, with continuing the information, to another piece of reproduction procedure information (2) 332. Meanwhile, end information is put in a state set at 0. The end information=0 is representative of not management information corresponding to the final procedure information.

Furthermore, the recordation control process 313 generates the reproduction procedure information (2) 332. The reproduction procedure information (2) also stores the information for utilization upon content reproduction similarly to the reproduction procedure information (1) 331, specifically, video/audio section data file name (Stream File name), time information, video header information, audio header information, Meta information comprising link information to stream data, etc., packet ID, and content management information comprising copy control information etc.

Furthermore, the recordation control process 313 links the reproduction procedure information (2) 332 to the reproduction management information 330 corresponding to the recordation content under recordation. Namely, a reproduction procedure information 332 name (Name) is registered to the reproduction management information 330, to execute a link process of between the reproduction procedure information 332 and the reproduction management information 330.

The recordation control process 313 sets the content recordation start time information about the recording medium (hard disk B) 312 to the content beginning position [In] in the corresponding domain of the reproduction management information to the reproduction procedure information (2) 332. The content end position [Out] is time data representative of an end position of content-recorded data to be updated as the content recordation process proceeds.

When the content recordation to the recording medium (hard disk B) 312 is over, the recordation control process 313 sets 0 in the continue information domain in the corresponding data of reproduction management information 330 to the reproduction procedure information (2). This is information representing that a same content is not continuously recorded to another new recording medium, i.e. information is not continuously recorded to another reproduction procedure information. Meanwhile, the end information is set to 1. The end information=1 represents as management information for the end procedure information.

By these processes, content recordation is continued from the recording medium (hard disk A) 311 to the recording medium (hard disk B) 312. Reproduction procedure information is individually generated corresponding to the storage information of each recording medium (hard disk). One piece of reproduction management information is generated to manage these plurality of pieces of reproduction procedure information.

During the reproduction process, a plurality of pieces of reproduction procedure information are extracted on the basis of one reproduction management information set correspondingly to the content. Based on the storage information of the respective pieces of reproduction procedure information, data reproduction processing is executed from different recording mediums in plurality, i.e. the recording medium (hard disk A) 311 and the recording medium (hard disk B) 312.

[Content Reproduction Process]

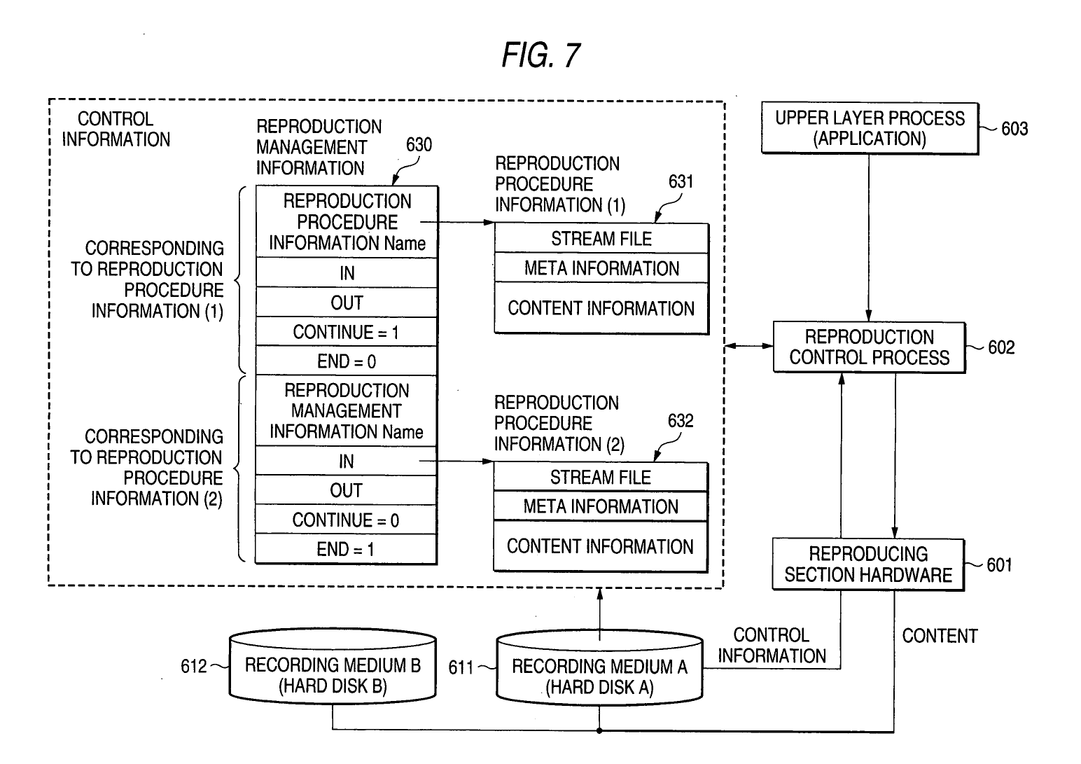

Now explained is a reproduction control process for reproduction-processing the content continuously recorded over a plurality of recording mediums, with reference to FIG. 7. FIG. 7 is a figure explaining a process arrangement in a content reproduction control process on an information reproduction apparatus of the invention. Incidentally, the hardware arrangement example of the information reproduction apparatus is as shown in FIG. 6. The dotted-lined area in FIG. 6 represents a hardware domain corresponding to the major configuration of a reproducing section hardware 601.

Under control of an upper layer process (application program) 603 shown in FIG. 7, a reproduction control process 602 is set to execute reproduction control each time a new reproduction process is caused, e.g. based on content. By the respective setting processes, the process is placed under control.

The reproduction control process 602 is explained in its processing. In the reproduction control process 602, first read out is reproduction management information 630 corresponding to a subject-of-reproduction content. The reproduction management information 630, in this embodiment, is stored on a recording medium A (hard disk A) 611. A reproduction control process 602 reads the reproduction management information 630 out of the recording medium A (hard disk A) 611.

Then, the reproduction procedure information name set in the reproduction management information 630 is looked up to read out reproduction procedure information (1) 631 and reproduction procedure information (2) 632 about the reproduction content. The reproduction control process 602 first executes a reproduction control process to a content stored in the recording medium A (hard disk A) 611, according to the reproduction management information 630 and the reproduction procedure information (1) 631.

Furthermore, the reproduction control process 602 verifies the continue information in the corresponding data storage domain of reproduction management information 630 to the reproduction procedure information (1) 631. From the fact of continue information=1, reproduction control process is continuously made for the content stored on the recording medium B (hard disk B) 612 according to the reproduction procedure information (2) 632 after ending the content reproduction according to the reproduction procedure information (1) 631.

Furthermore, the reproduction control process 602 verifies the continue information in the corresponding data storage area of reproduction management information 630 to the reproduction procedure information (2) 632. From continue information=0, it further verifies that there is no continuing reproduction procedure information. Meanwhile, from end information=0, verification is made as the final procedure information. When a reproduction point reaches the content end position [Out] in the corresponding data storage domain of reproduction management information 630 to the reproduction procedure information (2) 623, the process moves to an end process of the reproduction process, thus ending the reproduction.

In this manner, in the reproduction process of a content continuously recorded from the recording medium (hard disk A) 311 over to the recording medium (hard disk B) 312, the reproduction control process acquires the corresponding reproduction procedure information corresponding to the storage information of each recording medium (hard disk) depending upon one piece of reproduction management information, thus enabling to effect control based on the respective pieces of reproduction procedure information.

[Correspondence Between Content and Respective Control Information]

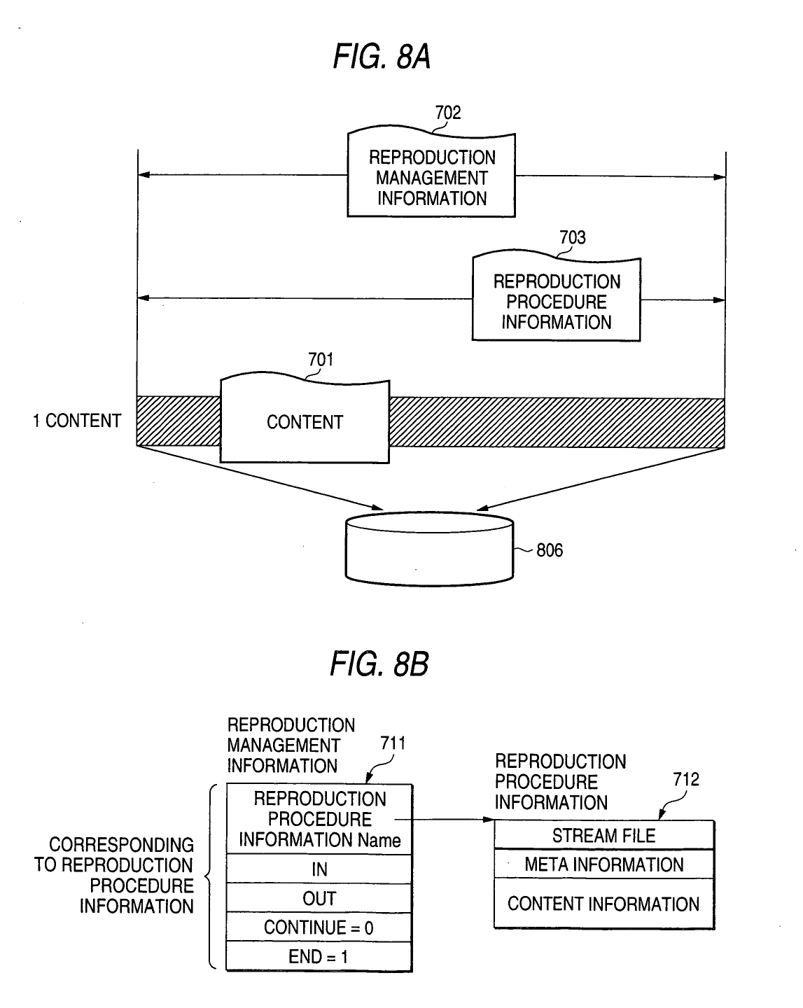

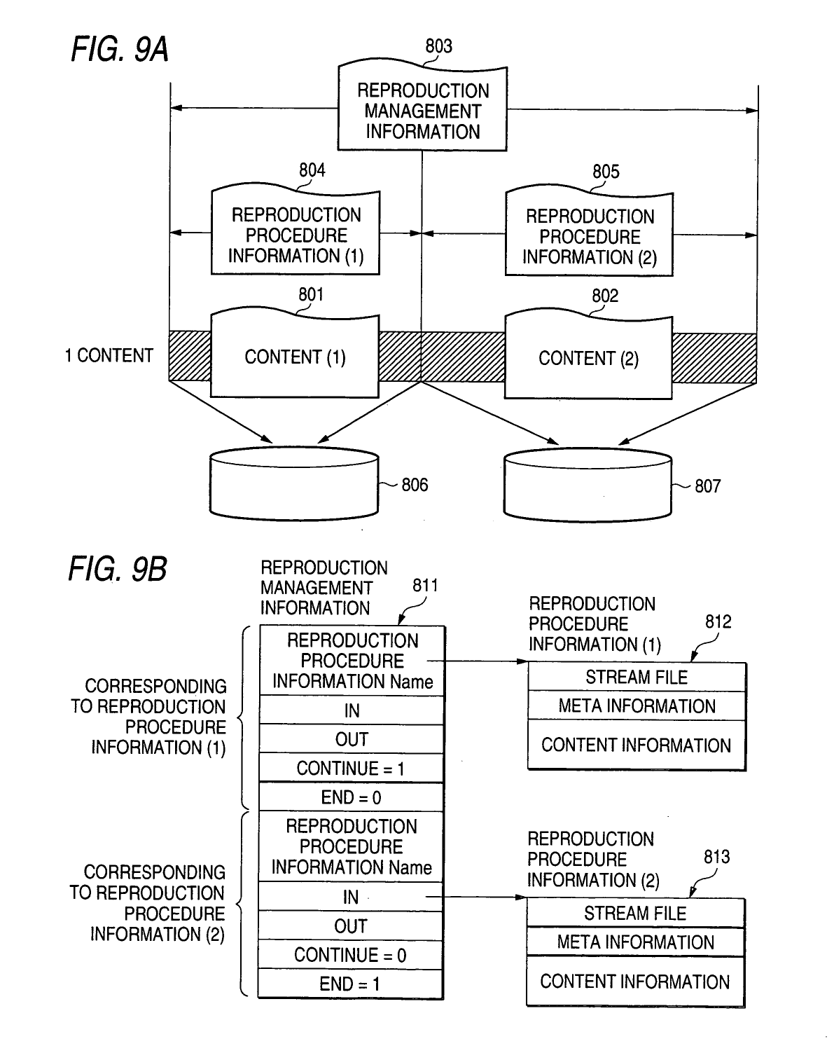

Now explanation is made on the correspondence between the reproduction management information and reproduction procedure information and the content, with reference to FIGS. 8 and 9.

Referring first to FIG. 8, explained is an example that one content is stored onto one recording medium. In the case that one content is stored to one storage medium, one content file 701 is set for the one content and stored to a storage medium 705. Together therewith, one piece of reproduction management information 702 and one piece of reproduction procedure information 703 are generated and stored to the recording medium 705. For the one piece of reproduction management information and one piece of reproduction procedure information, generation process is executed by the recordation control process as mentioned above, and stored together with the content to the storage medium.

As shown in FIG. 8B, in the case that one piece of reproduction management information and one piece of reproduction procedure information are generated for the one content, the corresponding information to one reproduction information 712 only is stored to reproduction management information 711.

The reproduction procedure information 712 stores the management information about the content continuously recorded to one recording medium. Specifically, it stores content management information comprising video/audio section data file names (stream file names), time information, video header information, audio header information, Meta information comprising link information to stream data and the like, packet ID, copy control information and so on.

Meanwhile, the corresponding management information to the reproduction procedure information 712 is set to the reproduction management information 711. Specifically, a name representative of the corresponding reproduction procedure information, a content beginning position [In] and a content end position [Out] as time information representative of the content beginning and end positions. 0 is set to the continue information representative of whether or not a same content is continuously recorded to the next reproduction procedure information, representing that recording is not made continuously to the next reproduction procedure information. Meanwhile, 1 is set to the end information storing domain, representing that there is no following reproduction procedure information and the final reproduction procedure information is corresponded to.

Referring next to FIG. 9, explained is an example that one content is stored onto two recording mediums. In the case that one content is stored to two storage mediums, two content files 801, 802 are set for the one content and respectively stored to storage mediums 806, 807, and further one piece of reproduction management information 803 and two pieces of reproduction procedure information 804, 805 are generated, as shown in FIG. 9A.

The two content files 801, 802 are respectively stored to the recording mediums 806, 807. For the one piece of reproduction management information 803 and the two pieces of reproduction management information 804, 805, generation process is executed by the recordation control process as mentioned above. Together with the content, the reproduction management information 803 and the reproduction procedure information 804 are stored to the recording medium 806 while the reproduction procedure information 805 is to the recording medium 807, respectively.

In the case that one piece of reproduction management information and two pieces of reproduction procedure information are generated for the one content as shown in FIG. 9B, the corresponding information to the two pieces of reproduction procedure information 812, 813 is stored to reproduction management information 811.

Reproduction procedure information (1) 812 and reproduction procedure information (2) 813 each store management information about the content continuously recorded on one different recording medium. Specifically, they store content management information comprising video/audio section data file names (stream file names), time information, video header information, audio header information, Meta information comprising link information to stream data and the like, packet ID, copy control information and so on.

Meanwhile, the corresponding management information to the reproduction procedure information (1) 812 and the reproduction procedure information (2) 813 is stored to the reproduction management information 811. Specifically, stored are a name representative of the corresponding reproduction procedure information, and a content beginning position [In] and a content end position [Out] as time information representative of the content beginning and end positions.

1 is set to the continue information of the corresponding reproduction management information 811 to the reproduction procedure information (1) 812, representing that recording is made continuously to the next reproduction procedure information. Meanwhile, 0 is set to the end information storing domain, representing that there is the following reproduction procedure information and the final reproduction procedure information is not corresponded to.

0 is set to the continue information of the corresponding reproduction management information 811 to the reproduction procedure information (2) 813, representing that recording is not made continuously to the next reproduction procedure information. Meanwhile, 1 is set to the end information storing domain, representing that there is no following reproduction procedure information and the final reproduction procedure information is corresponded to.

[Content Recordation Process Procedure]

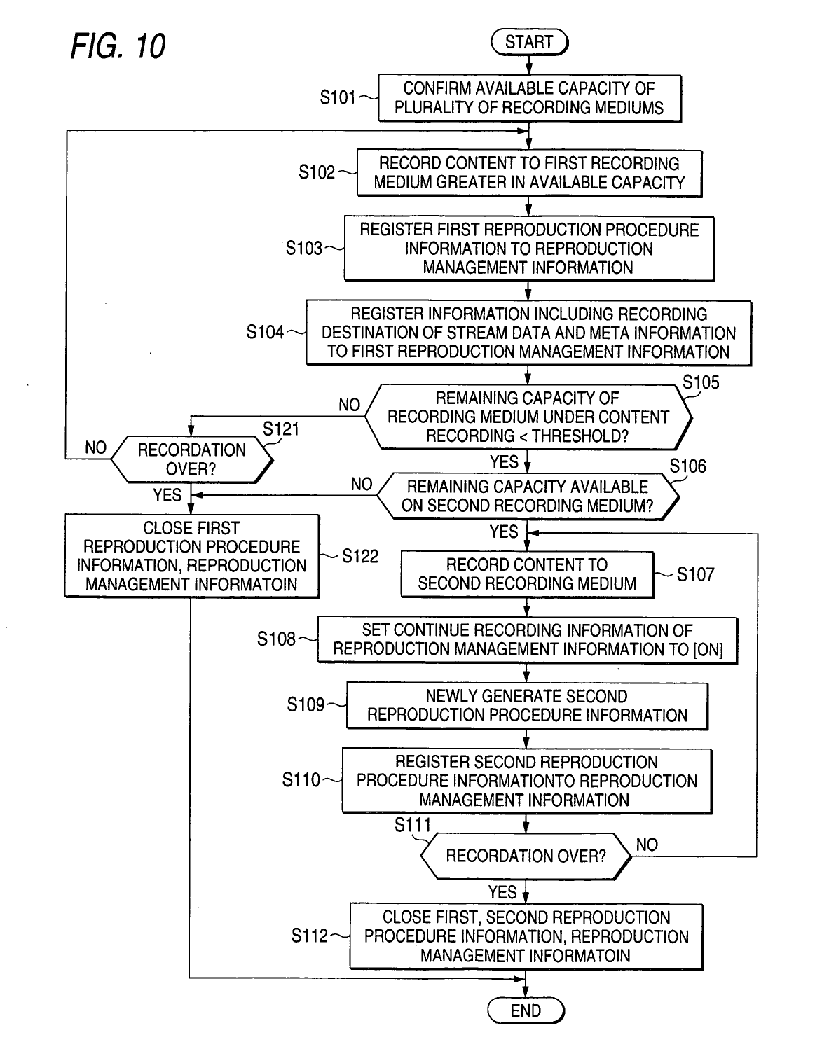

Now explained is a procedure of a content recordation process to be executed on the information recording apparatus of the invention, with reference to a flowchart of FIG. 10.

As was explained with reference to FIG. 5, content recordation process is executed by the recordation control process on the information recording apparatus of the invention. On hardware, the control section (CPU) for executing a program corresponding to the recordation control process functions as a recording control process executing section.

Explanation is made on the step processes shown in the flow of FIG. 10. In the case that there are a plurality of recording mediums capable of storing the content, the recordation control process at step S101 executes a selection process of which one is taken as a content recording start medium. Specifically, it acquires available capacity information about the plurality of recording mediums and selects a recording medium having greater available capacity. At step S102, content recordation process is started on the first recording medium thus selected. The recording content is data compressed MPEG2, for example.

At step S103, the recordation control process generates the corresponding reproduction management information to the content under recordation and links first reproduction procedure information thereto. Namely, a first reproduction procedure information name is registered to the reproduction management information, to execute a link process between the first reproduction procedure information and the reproduction management information.

Furthermore, at step S104, the information to be utilized upon reproducing the content is stored to the first reproduction procedure information. The storage information is content management information comprising a video/audio section data file name (stream file name), time information, video header information, Meta information comprising link information to stream data or the like, packet ID, copy control information, and so on.

Furthermore, at step S105, the recordation control process verifies the recording medium under content recordation, i.e. the remaining capacity of the first recording medium in this case, at a regular interval during recording the content, and compares it with a preset threshold. In case the remaining capacity of the first recording medium is equal to or greater than the threshold, it is determined at step S121 whether content recordation is over or not. In the case of not over, continued is the content recordation process to first recording medium of step S102. In the case content recordation is over, recordation-process ending process is made at step S122, i.e. the first reproduction procedure information and reproduction management information is closed, or stored to a predetermined storage area (recording medium), thus ending the process.

In the case determined at the step S105 that the remaining capacity on the first recording medium is less than the threshold, the process proceeds to step S106 where the remaining capacity is verified of the other recording medium (second recording medium). In case the remaining capacity on the second recording medium is equal to or greater than the threshold as a result of verification, the process proceeds to step S107. In case the remaining capacity on the second recording medium is less than the threshold, the process proceeds to step S122 where reproduction-process ending process is made at step S208, i.e. the first reproduction procedure information and reproduction management information is closed, or stored to a predetermined storage area (recording medium), thus ending the process.

In the case that the remaining capacity of the second recording medium is equal to or greater than the threshold, the content recordation to the second recording medium is continuously executed at step S107. At step s108, 1 is set to the continue information of the first reproduction procedure information of the reproduction management information. This is information representing that a same content is continuously recorded to the other recording medium and recordation is executed by continuing the information over to another piece of reproduction procedure information.

Furthermore, at step S109, second reproduction procedure information is generated. At step S110, the second reproduction procedure information is registered with the information similar to the first reproduction procedure information which is to be utilized upon reproducing the content.

Then, it is determined at step S111 whether content recordation is over or not. In the case of not over, continued is the content recordation process of step S107 to the second recording medium. In the case that content recordation is not over, then at step S112 reproduction-process ending process is made, i.e. the first reproduction procedure information, the second reproduction procedure and reproduction management information are closed, or stored to a predetermined storage area (recording medium), thus ending the process.

[Content Reproduction Process Procedure]

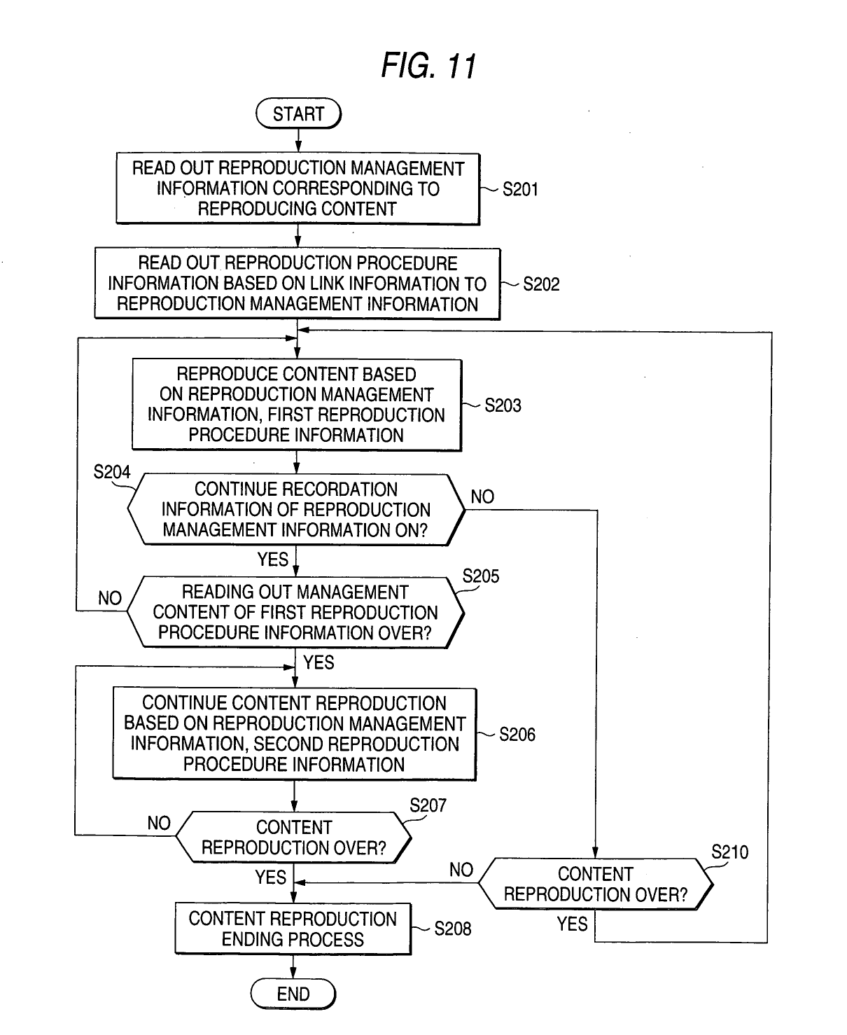

Now, explained is a content reproducing process procedure to be executed on the information reproduction apparatus, with reference to a flowchart of FIG. 11.

As was explained with reference to FIG. 7, the content reproduction process is to be executed by a reproduction control process on the information reproduction apparatus of the invention. On hardware, the control section (CPU) for executing the program corresponding to the reproduction control process functions as a reproduction control process executing section.

Explanation is made on the steps respectively shown in the flow of FIG. 11. The reproduction control process at step S201 first reads out the corresponding reproduction control information to a subject-of-reproduction content. Then, at step S202, the reproduction procedure information name set in the reproduction control information is looked up to read out the reproduction procedure information for the reproduction content. Where a plurality of pieces of reproduction procedure information are linked to the reproduction management information, the plurality of reproduction procedure information are read out.

At step S203, reproduction control process is executed for the content stored on the first recording medium according to the control information stored in the reproduction management information and first reproduction procedure information (first reproduction procedure information) set in the reproduction management information.

Furthermore, at step S204, the reproduction control process verifies the continue information of the first reproduction procedure information of the reproduction management information, and determines whether or not the continue information is ON (1). In the case the continue information is not ON (1), it is represented that a same content is not continuously recorded to the other recording medium and there is no reproduction procedure information to be continuously reproduced as the same content. At step S210, it is determined whether content reproduction is over or not. In the case of not over, the content reproduction process of step S203 is continued. In the case that content reproduction is over, a reproduction-process ending process is made at step S208, i.e. the first reproduction procedure information and reproduction management information are closed, or stored to a predetermined storage area (recording medium), thus ending the process.

At step S204, in the case that the continue information of the first reproduction procedure information of the reproduction management information is ON (1), it is represented that the same content is continuously recorded to the other recording medium and there is reproduction procedure information to be continuously reproduced as the same content. At step S205, it is waited until the end of reading a content out of the first recording medium according to the first reproduction procedure information. At step S206, reproduction control process is executed for the content stored in the second recording medium, according to the control information stored in the reproduction management information and second reproduction procedure information.

Furthermore, it is determined at step S208 whether content reproduction is over or not. In the case of not over, continued is the reproduction process of step S206 for the content stored in the second recording medium. In the case that content reproduction is over, a reproduction-process ending process is made at step S208, i.e. the first reproduction procedure information and the reproduction management information are closed, or stored to a predetermined storage area (recording medium), ending the process.

In this manner, in the content reproduction process, where content recordation has been continuously made over a plurality of recording mediums, acquired is the corresponding reproduction procedure information to the storage information about each recording medium, to effect control based on the respective pieces of reproduction procedure information.

Incidentally, although the foregoing embodiment explained the content recording medium centering on the hard disk, the present invention is applicable to the arrangement for recording a content on a recording medium in various kinds, e.g. a DVD, an optical disk, or a flash memory.

In the above, the present invention was detailed in the above while referring to particular embodiments. However, it is apparent that the ordinary skilled person can modify or substitute the embodiment in a range not departing from the gist of the invention. Namely, the invention was disclosed in the form of exemplification and not to be limitedly interpreted. In order to determine the gist of the invention, the claims described in the introductory part should be taken account of.

Incidentally, the series of processes explained in the description can be executed on hardware or software or by a combined configuration of the both. In the case to execute a process on software, the program with a process sequence recorded thereon is executed by being installed on a memory within a computer built in an exclusive hardware or by installing a program onto a general-purpose computer capable of executing various processes.

For example, the program can be previously recorded on a hard disk or ROM (Read Only Memory) as a recording medium. Otherwise, the program can be stored (recorded) temporarily or permanently on a removable recording medium such as a flexible disk, a CD-ROM (Compact Disc Read Only Memory), MO (Magnetooptical) disk, a DVD (Digital Versatile Disc), a magnet disk, a semiconductor memory or the like. Such a removable recording medium can be provided as so-called package software.

Incidentally, the program, besides installed to the computer from a removable recording medium as noted above, can be transferred from a download site onto the computer wirelessly or via a wire through a network such as LAN (Local Area Network) or the Internet so that the computer can receive the program transferred in that manner and has the program installed to an incorporated recording medium, such as a hard disk.

Incidentally, the processes described in the description may be chronologically executed according to the description but executed in parallel or individually in accordance with the process capability of the process executing apparatus or the necessity. Meanwhile, the system in the description is logical set arrangement of a plurality of apparatuses, not limited to those having the apparatuses of arrangements within the same housing.

### Industrial Applicability

As explained above, according to the arrangement of the invention, in an apparatus having a plurality of information recording means such as a plurality of hard disks or the like, generated are reproduction procedure information on which a reproducing procedure is recorded as reproduction control information corresponding to recording data, and reproduction management information on which link information to reproduction procedure information is stored. In the case of continuously executing data recordation to a plurality of information recording means, a plurality of pieces of reproduction procedure information are generated corresponding respectively to a plurality of pieces of reproduction procedure information, to provide a configuration storing link information to the plurality of pieces of reproduction procedure information to one piece of the reproduction management information. Accordingly, in a content reproduction process, even in case content recordation is being continuously executed to a plurality of recording mediums, reproduction procedure information corresponding to the storage information on each recording medium can be acquired based on one piece of reproduction management information, thus enabling to effect control based on the respective pieces of reproduction procedure information.

Furthermore, according to the arrangement of the invention, there is provided an arrangement that, in the case of continuously executing a data recordation process to a plurality of information recording means, a process of storing link information to a plurality of reproduction procedure information to one piece of reproduction management information is executed, and furthermore the corresponding data storage domain of an individual piece of reproduction procedure information stores a continue information (Continue) of whether or not a same content is recorded to the next piece of reproduction procedure information. Accordingly, in the content reproduction process, the reproduction procedure information is acquired corresponding to the storage information on each storage medium, based on one piece of reproduction management information, thus enabling to effect control based on the respective pieces of reproduction procedure information.

Furthermore, according to the arrangement of the invention, there is provided, in an information recordation process, an arrangement for executing a comparison process in available capacity for recording data between a plurality of information recording means, selecting information recording means having a greater available capacity and commencing a data recordation process, further executing a comparison process of a remaining capacity of information recording means under data recordation with a preset threshold, and continuously executing the data recordation process to another information recording means, hence enabling to utilize efficient, proper recording means.

1. An information recording apparatus for executing a data recordation process, the information recording apparatus characterized by comprising:
a plurality of information recording means for recording data; and
a recordation control process executing section for executing a data recordation process to the information recording means and a generation process of control information during data reproduction;
the recordation control process executing section having a configuration for
generating, as the control information, reproduction procedure information on which a reproducing procedure of reproducing data is stored and reproduction management information on which link information to the reproduction procedure information is stored, during the data recordation process; and wherein
in the case of continuously executing a data recordation process to a plurality of information recording means, a plurality of pieces of reproduction procedure information are generated corresponding respectively to the plurality of information recording means, to execute a process of storing link information to the plurality of reproduction procedure information to one piece of the reproduction management information.

2. An information recordation process according to claim 1, wherein the recordation control process executing section has a configuration for
executing, in the case of continuously executing a data recordation process to a plurality of information recording means, a process of storing the link information to the plurality of reproduction procedure information to one piece of the reproduction management information, and
executing a process of storing continue information representative of whether or not recording a same content in a corresponding data storage domain to individual pieces of reproduction procedure information, continuously to a next piece of reproduction procedure information.

3. An information recordation process according to claim 1, wherein the recordation control process executing section has a configuration for
executing, in the case of continuously executing a data recordation process to a plurality of information recording means, a process of storing the link information to the plurality of reproduction procedure information to one piece of the reproduction management information, and
executing a process of storing end information representative of whether or not corresponding to a final piece of reproduction procedure information, in a corresponding data storage domain to an individual piece of reproduction procedure information.

4. An information recordation process according to claim 1, wherein the recordation control process executing section has a configuration for
executing a process of storing, in each piece of the reproduction procedure information, management information on data continuously recorded on one recording medium, and storing information enabling to determine a storage position of the data.

5. An information recordation process according to claim 1, wherein the recordation control process executing section has a configuration for
executing a comparison process of an available capacity for recording data between the plurality of information recording means, and selecting information recording means having a greater available capacity thereby commencing a data recordation process.

6. An information recordation process according to claim 1, wherein the recordation control process executing section has a configuration for
executing a comparison process of a remaining capacity of the information recording means under data recording with a preset threshold, and executing continuously a data recordation process to an other information recording means on condition that the remaining amount becomes less than the threshold.

7. An information recordation process according to claim 1, wherein the recordation control process executing section has a configuration for
executing a process of generating first reproduction procedure information when commencing a data recordation process to the information recording means, and storing link information to the first reproduction procedure information to the reproduction management information, and
generating new second reproduction procedure information in the case of executing continuing data recording to different information recording means, storing link information to the second reproduction procedure information to the reproduction management information, and executing a setting process of continue information representative of having next reproduction procedure information in corresponding data storage domain to the first reproduction procedure information.

8. An information reproduction apparatus for executing a data reproducing process, the information reproduction apparatus characterized by comprising:
a plurality of information recording means for subject-of-reproducing data; and
reproduction control process executing section for executing a reproducing process of data stored on the information recording means, depending upon control information;
the reproduction control process executing section having a configuration for
acquiring, as the control information, reproduction procedure information on which a reproducing procedure of reproducing data is recorded and reproduction management information on which link information to the reproduction procedure information is stored, during data recordation process; and wherein
in a case that there are a plurality of pieces of reproduction procedure information set linked to the reproduction management information, the plurality of pieces of reproduction procedure information are switched in order and applied as control information, and reproduction-of-subject data is acquired based on an individual piece of reproduction procedure information from different information recording means thereby effecting a reproduction process.

9. An information reproduction apparatus according to claim 8, wherein
the reproduction management information stores, in a corresponding data storage domain to each piece of reproduction procedure information, continue information representative of whether or not recording a same content continuously to next reproduction procedure information, and
the reproduction control process executing section has a configuration for
executing a process of determining whether or not to continuously execute reproduction control depending on another piece of reproduction procedure information, depending upon a setting of continue information in reproduction management information set for reproduction procedure information corresponding to data under reproduction.

10. An information reproduction apparatus according to claim 8, wherein the reproduction control process executing section has a configuration for
acquiring, from the reproduction procedure information, management information on data continuously recorded on one recording medium and information enabling to determine a storage position of data thereby effecting a data reproduction control process.

11. An information recording method for an information recording apparatus having a plurality of information recording means for recording data, the information recording method characterized by comprising:
a control information generating step of generating reproduction procedure information on which a reproducing procedure is recorded as reproduction control information corresponding to recording data, and reproduction management information on which link information to the reproduction procedure information is stored, during the data recordation process; and wherein
the control information generating step is to execute a process that
in the case of continuously executing a data recordation process to a plurality of information recording means, a plurality of pieces of reproduction procedure information are generated corresponding respectively to the plurality of information recording means, to store link information to the plurality of reproduction procedure information to one piece of the reproduction management information.

12. An information recording method according to claim 11, wherein, in the case of continuously executing a data recordation process to a plurality of information recording means, a process is executed of storing the link information to the plurality of reproduction procedure information to one piece of the reproduction management information, and
a process is executed of storing continue information representative of whether or not recording a same content in a corresponding data storage domain to individual pieces of reproduction procedure information, continuously to a next piece of reproduction procedure information.

13. An information recording method according to claim 11, wherein, in the case of continuously executing a data recordation process to a plurality of information recording means, a process is executed of storing the link information to the plurality of reproduction procedure information to one piece of the reproduction management information, and
a process is executed of storing end information representative of whether or not corresponding to a final piece of reproduction procedure information, in a corresponding data storage domain to an individual piece of reproduction procedure information.

14. An information recording method according to claim 11, further including a step of storing, in each piece of the reproduction procedure information, management information on data continuously recorded on one recording medium, and storing information enabling to determine a storage position of the data.

15. An information recording method according to claim 11, further including a step of executing a comparison process of an available capacity for recording data between the plurality of information recording means, and selecting information recording means having a greater available capacity thereby commencing a data recordation process.

16. An information recording method according to claim 11, further including a step of executing a comparison process of a remaining capacity of the information recording means under data recording with a preset threshold, and executing continuously a data recordation process to another information recording means on condition that the remaining amount becomes less than the threshold.

17. An information recording method according to claim 11, further including a step of executing a process of generating first reproduction procedure information when commencing a data recordation process to the information recording means, and storing link information to the first reproduction procedure information to the reproduction management information, and
generating new second reproduction procedure information in the case of executing continuing data recording to different information recording means, storing link information to the second reproduction procedure information to the reproduction management information, and executing a setting process of continue information representative of having next reproduction procedure information in corresponding data storage domain to the first reproduction procedure information.

18. An information reproducing method for an information reproducing apparatus having a plurality of information recording means for subject-of-reproducing data, the information reproducing method characterized by comprising:
a control information acquiring step of acquiring, as the control information, reproduction procedure information on which a reproducing procedure of reproducing data is recorded and reproduction management information on which link information to the reproduction procedure information is stored, during the data recordation process; and
a reproduction control process step that, in a case that there are a plurality of pieces of reproduction procedure information set linked to the reproduction management information, the plurality of pieces of reproduction procedure information are switched in order and applied as control information, and reproduction-of-subject data is acquired based on an individual piece of reproduction procedure information from different information recording means thereby effecting a reproduction process.

19. An information reproducing method according to claim 18, wherein
the reproduction management information stores, in a corresponding data storage domain to each piece of reproduction procedure information, continue information representative of whether or not recording a same content continuously to next reproduction procedure information, and
the reproduction control process step includes
a step of executing a process of determining whether or not to continuously execute reproduction control depending on another piece of reproduction procedure information, depending upon a setting of continue information in reproduction management information set for reproduction procedure information corresponding to data under reproduction.

20. An information reproducing method according to claim 18, wherein the reproduction control process step includes
a step of acquiring, from the reproduction procedure information, management information on data continuously recorded on one recording medium and information enabling to determine a storage position of data thereby effecting a data reproduction control process.

21. A computer program for executing an information recordation process in an information recording apparatus having a plurality of information recording means for recording data, the computer program characterized by comprising:
a control information generating step of generating reproduction procedure information on which a reproducing procedure is recorded as reproduction control information corresponding to recording data, and reproduction management information on which link information to the reproduction procedure information is stored, during the data recordation process; and
the control information generating step is set such that
in the case of continuously executing a data recordation process to a plurality of information recording means, a plurality of pieces of reproduction procedure information are generated corresponding respectively to the plurality of information recording means, to store link information to the plurality of reproduction procedure information to one piece of the reproduction management information.

22. A computer program for executing an information recordation process in an information recording apparatus having a plurality of information recording means for recording subject-of-reproducing data, the computer program characterized by comprising:
a control information acquiring step of acquiring, as the control information, reproduction procedure information on which a reproducing procedure of reproducing data is recorded and reproduction management information on which link information to the reproduction procedure information is stored, during the data recordation process; and
a reproduction control process step that, in a case that there are a plurality of pieces of reproduction procedure information set linked to the reproduction management information, the plurality of pieces of reproduction procedure information are switched in order and applied as control information, and reproduction-of-subject data is acquired based on an individual piece of reproduction procedure information from different information recording means thereby effecting a reproduction process.
